(19) United States
(12) Patent Application Publication
(10) Pub. No.: US 2017/0046497 A1
(43) Pub. Date: Feb. 16, 2017

(54) Sensory Density and Diversity for Living in Place

(71) Applicants: AT&T INTELLECTUAL PROPERTY I, L.P., Atlanta, GA (US); AT&T MOBILITY II LLC, Atlanta, GA (US)

(72) Inventors: Vc Ramesh, Plano, TX (US); Michael G. Branam, Lawrenceville, GA (US); Philip Edward Brown, Westfield, NJ (US); Lee Callaway, Alpharetta, GA (US); Halim Damerdji, Los Altos, CA (US); Shilpi Harpavat, Plano, TX (US); Azeddine Kasmi, Dallas, TX (US); Terri A. Lewis, Atlanta, GA (US); Sunil Nakrani, Peachtree City, GA (US); Tung Nguyen, Norcross, GA (US); Maruthi Nori, Cumming, GA (US); Prince Paulraj, Coppell, TX (US); Homayoun Torab, Snellville, GA (US); Christopher L. Tsai, Plano, TX (US)

(73) Assignees: AT&T MOBILITY II LLC, Atlanta, GA (US); AT&T INTELLECTUAL PROPERTY I, L.P., Atlanta, GA (US)

(21) Appl. No.: 14/823,213

(22) Filed: Aug. 11, 2015

(51) Int. Cl. G06F 19/00; G06F 17/30

(52) U.S. Cl. CPC G06F 19/3418; G06F 17/30477

(57) ABSTRACT

One or more simulations are generated for in-home monitoring. The simulations model sensory detection of a user's physical activities using a different number and/or a different combination of sensors. Each different simulation may thus be associated with an accuracy and a cost, depending on the number and/or combination of sensors. The simulations thus present a range of sensory configurations that balance accuracy and affordability, from which an optimum sensory solution may be determined for the in-home monitoring.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Most people wish to independently live in their own home. In previous years, safety and security could be obstacles to independent living. Today, though, electronic monitoring services could enable many people to independently live in their own home with little assistance. Unfortunately, though, monitoring services may be too expensive for many people.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-3 are simplified schematics illustrating an environment in which exemplary embodiments may be implemented;

FIG. 4 is a more detailed schematic illustrating an operating environment, according to exemplary embodiments;

FIGS. 5-6 are schematics illustrating an activity profile, according to exemplary embodiments;

FIGS. 7-8 are schematics illustrating generation of a user's physical activities, according to exemplary embodiments;

FIG. 9 is a schematic illustrating sensory definitions, according to exemplary embodiments;

FIGS. 10-11 are schematics illustrating sensory associations, according to exemplary embodiments;

FIGS. 12-13 are schematics illustrating generation of sensory events, according to exemplary embodiments;

FIGS. 14-16 are more detailed schematics illustrating output generation, according to exemplary embodiments;

FIGS. 17-18 are more detailed schematics illustrating the activity profile, according to exemplary embodiments;

FIG. 19 is a schematic activity inferences, according to exemplary embodiments;

FIGS. 20-21 are flowcharts illustrating a method or algorithm for sensory simulations, according to exemplary embodiments; and

FIGS. 22-27 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

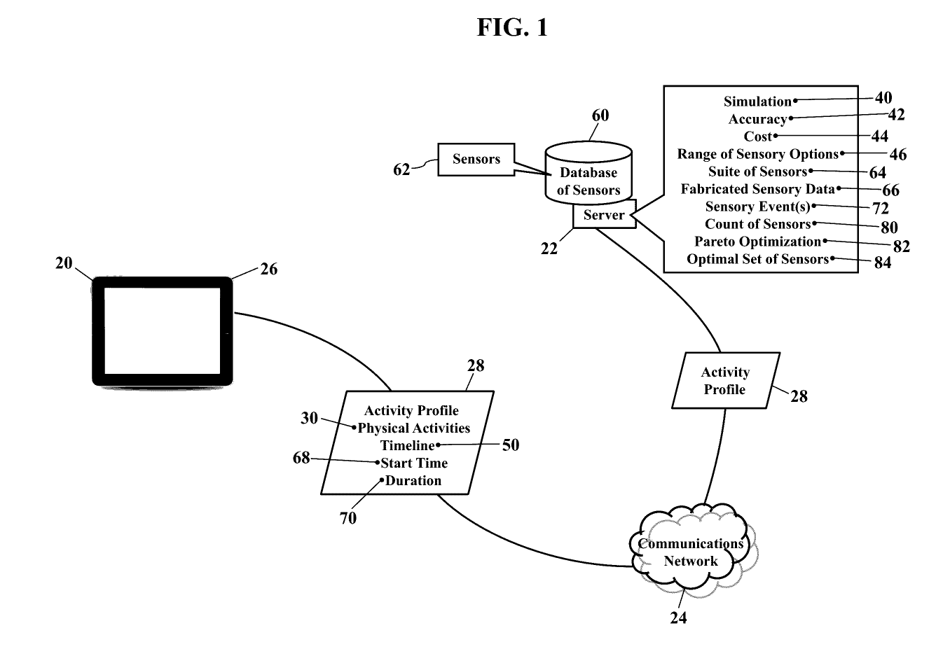

FIGS. 1-3 are simplified schematics illustrating an environment in which exemplary embodiments may be implemented. FIG. 1 illustrates a client device 20 that communicates with a server 22 via a communications network 24. The client device 20 is illustrated as a mobile tablet computer 26. The client device 20, though, may be any processor-controlled device, as later paragraphs will explain. Regardless, a user of the tablet computer 26 establishes an activity profile 28. In simple words, the activity profile 28 describes the user's physical activities 30 for which in-home monitoring is desired. As the reader likely understands, many services are available for in-home monitoring of occupants. These monitoring services utilize cameras and sensors that are installed throughout a home or other environment. Data from the cameras and sensors may be remotely analyzed to predict when an occupant needs medical care or other emergency service. That is, the data from the cameras and sensors may be analyzed to predict and/or confirm the user's physical activities 30, thus ensuring the user is physically behaving according to routine. If the user is not behaving according to routine (such as lying stationary on a floor), help may be automatically summoned.

Monitoring services, though, can be expensive. The purchase and installation of cameras and sensors can be difficult and costly. Indeed, most homes will require multiple cameras and multiple sensor installations in order to ensure accurate monitoring and prediction. Moreover, broadband access may be required, which is another expense. Many users, then, are concerned that they cannot afford an in-home monitoring service.

Exemplary embodiments, though, optimize accuracy and cost. Exemplary embodiments generate one or more electronic simulations 40 of a monitoring environment for the user's physical activities 30. Each simulation 40 outputs a different sensory plan for different accuracies 42 and different costs 44. For example, one of the simulations 40 may saturate the simulation 40 with a dense and diverse suite of sensors that ensures all the user's physical activities 30 are comprehensively monitored and described in great detail. Such a comprehensive sensory plan obviously monitors and predicts the user's physical activities 30 with very high accuracy 42. However, many users cannot afford such a dense and diverse suite of sensors. Exemplary embodiments may thus also generate additional electronic simulations 40 that utilize fewer sensors for less cost 44, but that also reduce the accuracy 42. Exemplary embodiments may even generate a range 46 of sensory options, all having different accuracies 42 and different costs 44.

Exemplary embodiments thus present a balance. Exemplary embodiments determine the density and diversity of sensors that are needed to monitor the user's physical activities 30, according to different accuracies 42 and different costs 44. Exemplary embodiments thus balance detection of the user's physical activities 30 with the costs 44 of sensor installations and resultant accuracies 42. In simple words, exemplary embodiments quantify a tradeoff between accuracy 42 and affordability. The user may thus choose a sensory installation package that best suits her budget.

FIG. 1 thus illustrates the activity profile 28. When the user wishes to investigate the costs of a monitoring service, the user completes the activity profile 28. The activity profile 28 describes or profiles the user's physical activities 30 for which the simulation 40 is desired. For example, suppose the user of the tablet computer 26 keeps a detailed log of her daily activities. She may thus confidently predict the room location and start and stop times of her daily breakfast. As we all know, most people are creatures of habit. We generally have a daily routine. The activity profile 28 may thus describe the window of time in which the user generally prepares and eats breakfast. Similarly, the activity profile 28 may also describe the windows of time at which the user generally prepares and eats lunch and dinner. The activity profile 28 may further describe other physical activities for which monitoring is desired, such as a daily dressing routine in a bedroom. The activity profile 28 may even include estimated times of toileting in a bathroom, especially when mobility is a concern. The activity profile 28 may also include infrequent and even random physical activities 30, such as grocery shopping and laundry, which later paragraphs will explain. The activity profile 28 may thus be a simple description or comprehensive timeline 50 of the user's physical activities 30, again as later paragraphs will explain in more detail.

The server 22 receives the activity profile 28. Once the tablet computer 26 generates the activity profile 28, the tablet computer 26 sends the activity profile 28 to the server 22 via the communications network 24. When the server receives the activity profile 28, the server 22 inspects the activity profile 28 for the user's physical activities 30. The server 22 may then consult a database 60 of sensors for each physical activity 30 specified in the activity profile 28. The database 60 of sensors stores electronic database associations between different physical activities 30 and different sensors 62. The server 22 may thus query the database 60 of sensors for any physical activity 30 and retrieve the corresponding sensor(s) 62.

Daily breakfast provides an example. Suppose that the activity profile 28 describes a daily preparation of breakfast in the kitchen. The server 22 queries the database 60 of sensors for any moniker that describes food preparation in a kitchen environment. Assume the server 22 queries for a textual description of “breakfast” and/or “kitchen.” The server 22 may thus retrieve electronic database associations with a motion sensor, a heat sensor, and a carbon monoxide sensor that monitor food preparation in a kitchen environment. The server 22 thus knows what sensors 62 are associated with the user's physical activity 30 of preparing breakfast in the kitchen.

The server 22 may saturate the simulation 40. As the server 22 inspects the activity profile 28, the server 22 may query for each physical activity 30 listed in the activity profile 28. The server 22 retrieves the corresponding sensors 62 from the database 60 of sensors that are associated with each physical activity 30 in the activity profile 28. For example, if the user wants the simulation 40 to monitor her living room exercises, the server 22 retrieves the sensors 62 that correspond with “living room” and/or “exercise.” Likewise, if the user wants the simulation 40 to monitor her “toileting” activities, the server 22 retrieves the corresponding sensors 62 from the database 60 of sensors. The server 22 may thus retrieve a dense and diverse suite 64 of sensors that comprehensively simulates or predicts the user's physical activities 30 with high accuracy 42.

The server 22 may also retrieve fabricated sensory data 66. Now that the server 22 knows the sensors 62 needed to simulate monitoring of the user's physical activities 30, the server 22 may require sensory outputs that mimic real observation. That is, the server 22 may generate the simulation 40 using the fabricated sensory data 66 that mimics an actual, tangible output generated by each sensor 62 associated with the physical activity 30. For example, if the server 22 determines a heat sensor would be required for simulating detection of the user's kitchen activities, the server 22 may retrieve the fabricated sensory data 66 that represents real time, real world outputs from a heat sensor. The fabricated sensory data 66 may be based on historical physical data and/or historical patterns observed from real, physical sensors deployed in homes, offices, and other monitored environments. Actual, tangible, archived output data from a heat sensor installed in the field, for example, may be retrieved and used for the simulation 40. Indeed, the fabricated sensory data 66 may additionally or alternatively be based on any statistical distribution of a group or population of sensors actually sending output data. However the fabricated sensory data 66 is generated, the server 22 may retrieve the fabricated sensory data 66 that corresponds to each one of the sensors 62 retrieved from the database 60 of sensors.

The server 22 may then generate the simulation 40. Once the user's physical activities 30 are defined by the activity profile 28, the server 22 may begin generating the simulation 40. The activity profile 28 specifies the timeline 50 of the user's physical activities 30 throughout a day, month, or any other interval of time. The server 22 thus knows the start time 68 and the duration 70 for each one of the user's physical activities 30. The server 22 may thus recreate the timeline 50 of the user's physical activities 30 by simulating sensory events 72. That is, the server 22 may simulate sensory detection of the user's breakfast preparation by simulating the sensory events 72 detected by the motion sensor and the heat sensor associated with the kitchen environment (as earlier explained). The server 22, in other words, retrieves and replays or logs the fabricated sensory data 66 associated with the motion sensor and the heat sensor for the duration 70 in the activity profile 28. At the start time 68 of the next physical activity 30 in the timeline 50, the server 22 retrieves and simulates the corresponding fabricated sensory data 66 associated with the corresponding sensors 62. The server 22 continues simulating the sensory events 72 associated with each physical activity 30 in the activity profile 28, according to the timeline 50. The timeline 50 thus determines what sensors 62 are instantiated at what start time 68 and for the duration 70, using the corresponding fabricated sensory data 66.

The server 22 may also generate an initial value of the accuracy 42. Once the server 22 simulates the sensory events 72 associated with some or all of the physical activities 30 in the activity profile 28, the server 22 may generate the initial accuracy 42. As the above paragraphs explained, the initial accuracy 42 is determined when saturating the simulation 40 with all the sensors 62 for each physical activity 30 in the activity profile 28. The server 22 may thus ingest all the fabricated sensory data 66 for all the sensors 62 to simulate detection of the user's physical activities 30. The server 22, in other words, models the living environment with a dense and diverse suite 64 of sensors that comprehensively monitors the user's physical activities 30 with the high initial accuracy 42. Such a highly detailed and comprehensive baseline simulation 40 of the living environment makes recognition and prediction relatively easy. The server 22 may also generate a saturated cost 44 for the dense and diverse suite 64 of sensors.

The server 22 may also degrade the accuracies 42. As the above paragraphs explained, such a dense and diverse suite 64 of sensors may be unsuited to many customers. Some users may have cost concerns. Some users may have installation concerns. Whatever the reason, some users may prefer a more limited suite of sensors in exchange for a lower cost and/or an easier installation. Exemplary embodiments, then, may reduce the number or count 80 of the sensors 62 and re-simulate the sensory events 72 associated with each physical activity 30 in the activity profile 28. The server 22, for example, may remove or eliminate any one of the sensors 62 from the saturated living environment. The server 22 determines the count N (illustrated as reference numeral 80) of all the sensors 62 for each physical activity 30 in the activity profile 28. The server 22 may then rerun or regenerate the simulation 40 using a reduced number or count (e.g., N−1) of the sensors 62. The server 22 may then again determine or calculate the degraded accuracy 42 using the reduced count (e.g., N−1) sensors 62 and a corresponding degraded cost 44.

A Pareto optimization 82 may be used. The server 22 may successively generate the simulation 40, with each iteration or run using a lesser number of the sensors 62. The server 22 tests the resulting degradation in activity recognition and assigns the corresponding degraded accuracy 42 and the corresponding degraded cost 44. Note that exemplary embodiments do not change the underlying physical activity 30, but only an observability of the physical activity 30 via the sensors 62. The Pareto optimization 82 quantifies the tradeoff between the different accuracies 42 and affordability (e.g., the costs 44). Exemplary embodiments may thus use the fabricated sensory data 66 to tune the parameters of the Pareto optimization 82. Exemplary embodiments thus output an optimal set 84 of sensors for any given desired accuracy 42. Constraints may be imposed on the Pareto optimization 82 to ensure that the simulation 40 of the underlying physical activities 30 is not affected by removal of the sensors 62.

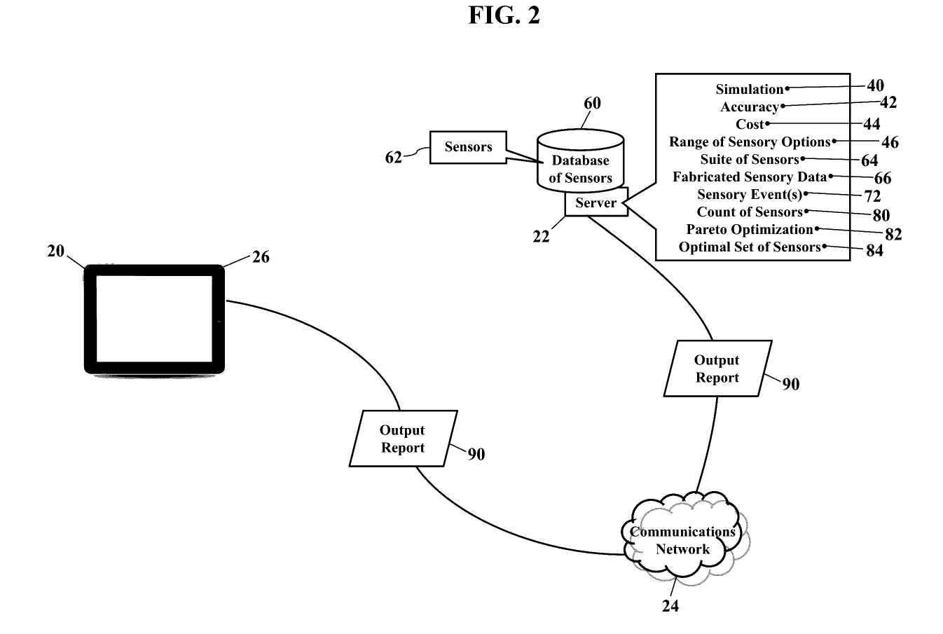

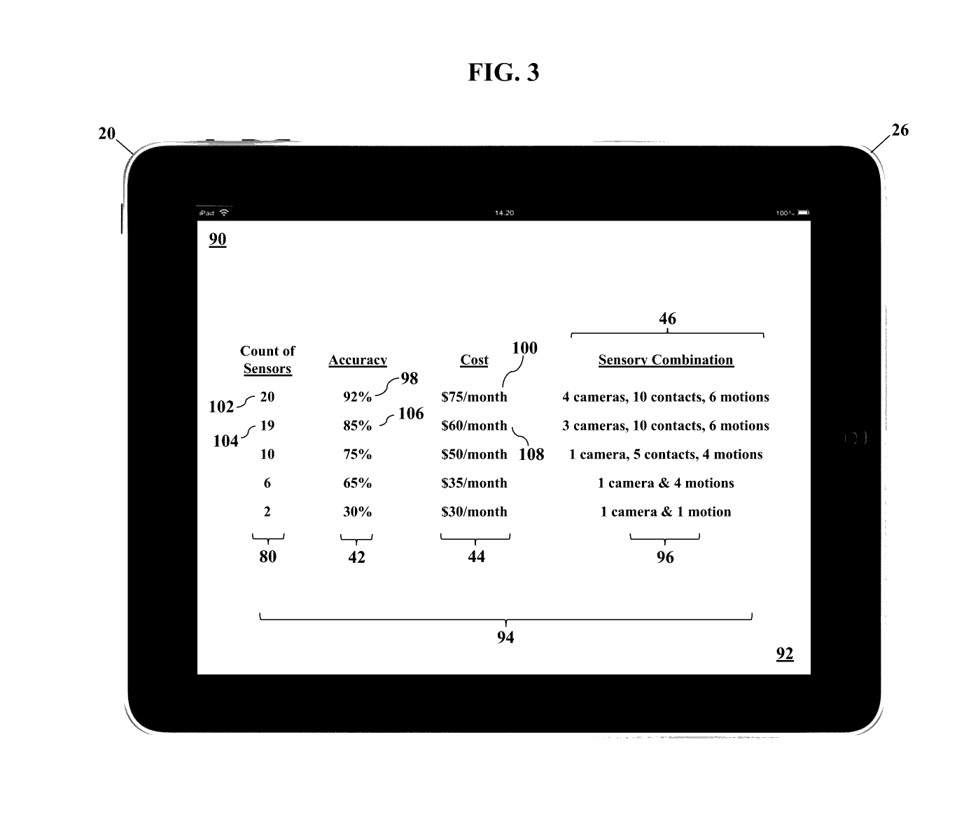

FIGS. 2-3 illustrate an exemplary output report 90. The server 22 generates the output report 90 that summarizes the different simulations 40 generated using different counts 80 of the sensors. FIG. 2 illustrates the server 22 sending the output report 90 via the communications network 24 to a network address associated with the client device 20 (such as the mobile tablet computer 26). The output report 90 may be sent as packets of data according to a packet protocol, such as any of the Internet Protocols. When the client device 20 receives the output report 90, the client device 20 may process or generate the output report 90 for display. FIG. 3, for example, illustrates the mobile tablet computer 26 displaying the output report 90 by a display device 92. FIG. 3 illustrates the output report 90 as a table 94 that summarizes each iteration with its associated accuracy 42 and the cost 44 for different sensory combinations 96. For example, the output report 90 lists an initial accuracy 98 and a saturated cost 100 for the initial N number of sensors (illustrated as reference numeral 102). The output report 90, in other words, summarizes a baseline simulation that saturates the living environment with the full suite of sensors associated with each physical activity in the activity profile (illustrated, respectively, as reference numerals 64, 30, and 28 in FIG. 2). The output report 90 may then have columnar/row entries for the (N−1) iteration that removed a sensor (illustrated as reference numeral 104) and the resulting degraded accuracy 106 and the corresponding degraded cost 108.

As FIG. 3 also illustrates, the range 46 of sensory alternatives may be generated. Exemplary embodiments may continue recalculating the accuracies 42, with each successive iteration using a lesser number of the sensors 62. Again, if N represents all the sensors 62 for the saturated living environment (that is, the N sensors 62 for each physical activity 30 in the activity profile 28 illustrated in FIG. 2), the server 22 may successively rerun the simulation 40 using (N−1), (N−2), . . . , (N−x) sensors 62. Each successive degraded accuracy 106 is determined, along with each corresponding degraded cost 108 The output report 90 may thus present the range 46 of sensory alternatives, outlining the different accuracies 42 and the different costs 44 for each sensory scenario.

Exemplary embodiments thus balance accuracy and affordability. As each simulation 40 may remove one or more of the sensors 62, exemplary embodiments may test the resulting degradation in activity recognition. The output report 90 thus graphically presents different balance point(s) between activity recognition accuracy and sensor affordability. A very high value or level of the accuracy 42 may require many sensors 62, which may be too costly for some users. However, at some point the number of the sensors 62 may be too low, producing a low accuracy 42 that is unacceptable to the user. The range 46 of sensory alternatives may thus visually present acceptable compromises between the accuracy 42 and the cost 44. Again, then, the user may thus choose a sensory installation package that best suits her needs and her budget.

Removal may be random or purposeful. If exemplary embodiments reduce the number or count 80 of the sensors 62 when regenerating the simulation of the physical activities 30, removal may be random. That is, the server 22 may randomly select any one (1) or more of the sensors 62 for removal and then regenerate the simulation 40 using the reduced number or count of the sensors 62. However, the server 22 may also or alternatively strategically remove any sensor 62. For example, the server 22 may selectively remove the sensors 62 according to cost. Some sensors (such as video cameras) may be more expensive than others, perhaps due to purchase price and/or installation cost. Simply put, the most expensive sensor 62 may be the first eliminated. Another strategy, though, may remove sensors based on detection. There may be a sensor 62 that is only associated with a single physical activity 30. If that physical activity 30 is only rarely and/or randomly observed in the user's activity profile 28, the server 22 may first select that sensor 62 associated with the rarely and/or randomly observed physical activity 30. Still another strategy may remove sensors based on location. Some locations within the user's home may be less suited to sensory detection, so perhaps the sensors in these unsuited locations are candidates for removal. For example, a room in the user's home may have poor wireless signal strength, thus inhibiting installation of wireless sensors. Any sensors associated with poor wireless reception or interference may be candidates for removal. Indeed, exemplary embodiments may utilize any removal strategy that suits the user's needs, interests, or desires.

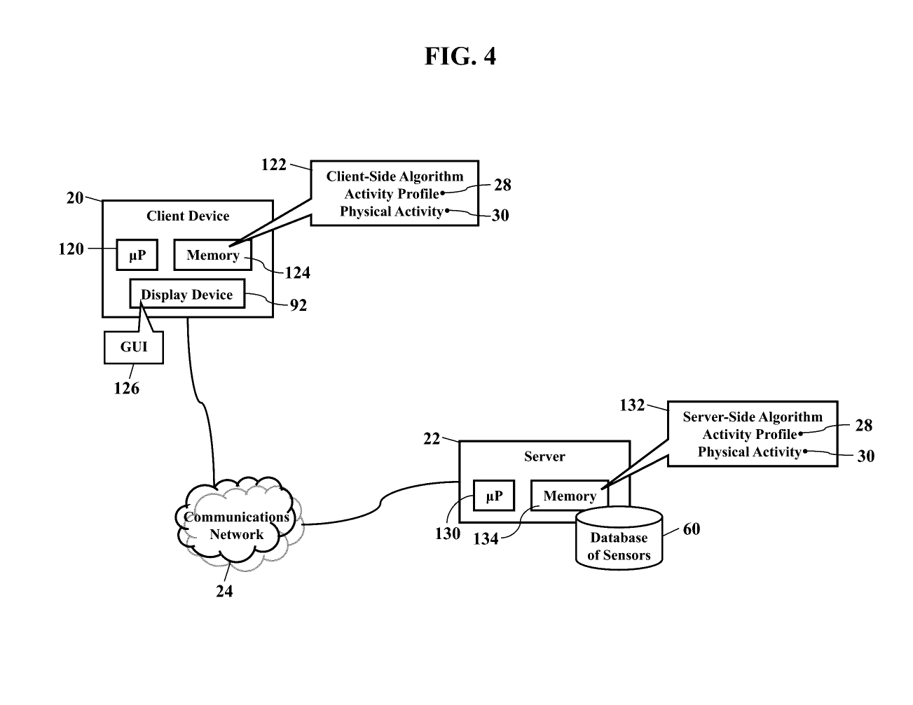

FIG. 4 is a more detailed schematic illustrating an operating environment, according to exemplary embodiments. Here the client device 20 may have a processor 120 (e.g., “μP”), application specific integrated circuit (ASIC), or other component that executes a client-side algorithm 122 stored in a local memory 124. The client-side algorithm 122 may cause the processor 120 to generate a graphical user interface (“GUI”) 126 that is displayed on the display device 92 (such as a touch screen display common on many mobile devices). The server 22 may also have a processor 130 (e.g., “μP”), application specific integrated circuit (ASIC), or other component that executes a server-side algorithm 132 stored in a local memory 134. The client-side algorithm 122 and/or the server-side algorithm 132 include instructions, code, and/or programs that may cooperate in a client-server relationship to analyze the user's physical activities 30 in the activity profile 28. The client-side algorithm 122 and/or the server-side algorithm 132 may cause their respective processors 120 and 130 to performs operations or instruct or cause another element to perform operations.

Exemplary embodiments may be applied regardless of networking environment. Exemplary embodiments may be easily adapted to stationary or mobile devices having cellular, wireless fidelity (WI-FI®), near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations”, this could include the processor performing the operations directly and/or facilitating, directing, or cooperating with another device or component to perform the operations.

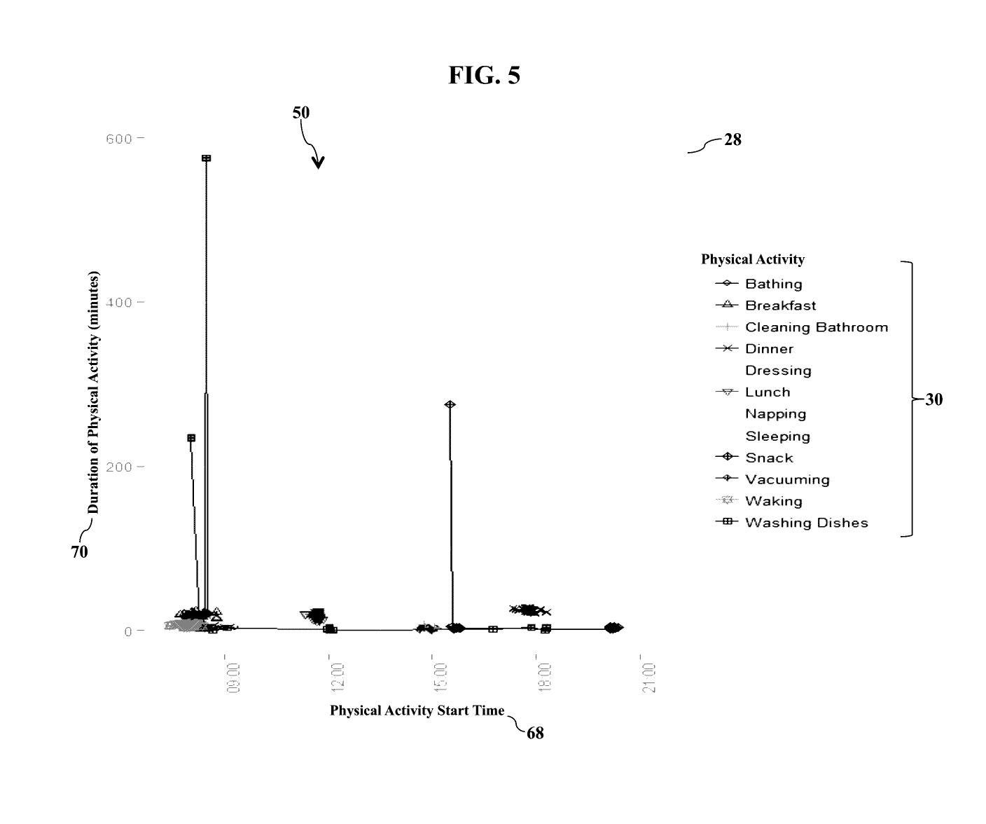

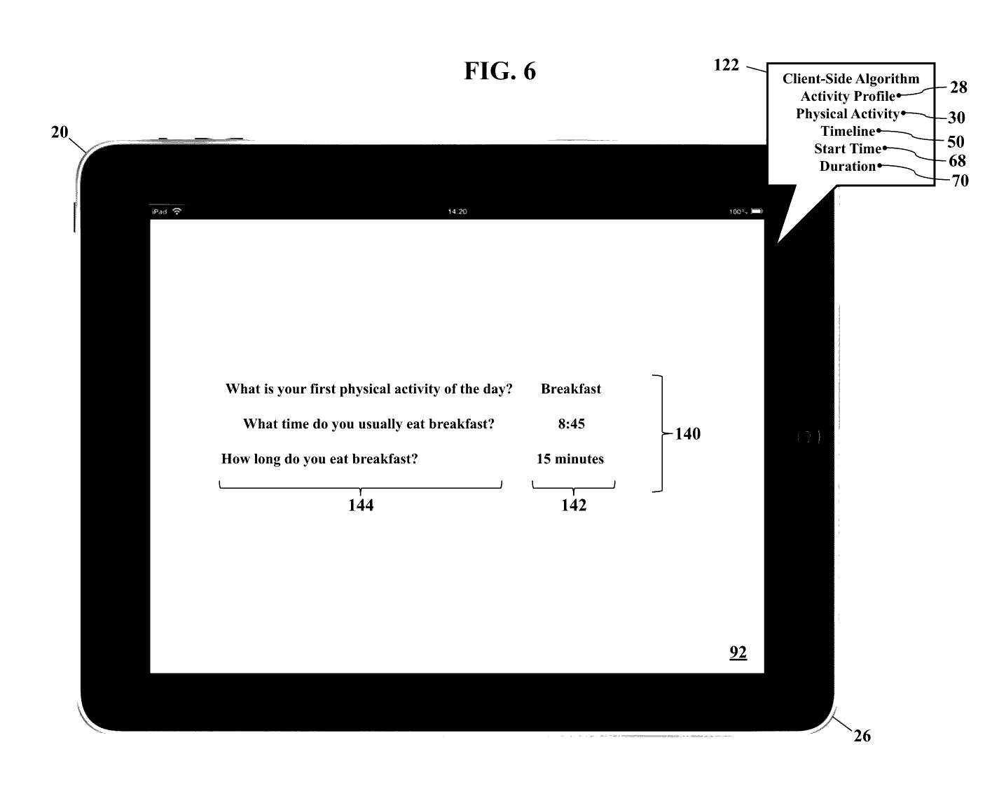

FIGS. 5-6 are schematics illustrating the activity profile 28, according to exemplary embodiments. The activity profile 28 describes the user's physical activities 30. While the activity profile 28 may have any form and content, FIG. 5 illustrates a graphical representation of the timeline 50 of the user's physical activities 30 during waking hours. Each physical activity 30 is associated with its corresponding start time 68 and the duration 70. The reader may understand that different users will likely have different physical activities 30, depending on physical abilities and interests. The activity profile 28 may thus be tailored to each user.

FIG. 6 illustrates a simple questionnaire 140. As each user's physical activities 30 may differ, the activity profile 28 may be personalized to suit the particular user's physical abilities and interests. FIG. 6 thus illustrates the tablet computer 26 displaying the questionnaire 140 on the display device 92. The questionnaire 140 solicits answers 142 to questions 144 that help determine the user's physical activities 30. The client-side algorithm 122, for example, may retrieve and present a series of the questions 144 designed to draw out the user's textual or spoken responses. In simple words, the client-side algorithm 122 may be a downloadable software application that assists the user in specifying her activity profile 28. The user enters her answers 142, and the client-side algorithm 122 assists the user in defining the timeline 50 of her physical activities 30. The activity profile 28 thus electronically describes each physical activity 30, its corresponding start time 68, and its corresponding duration 70.

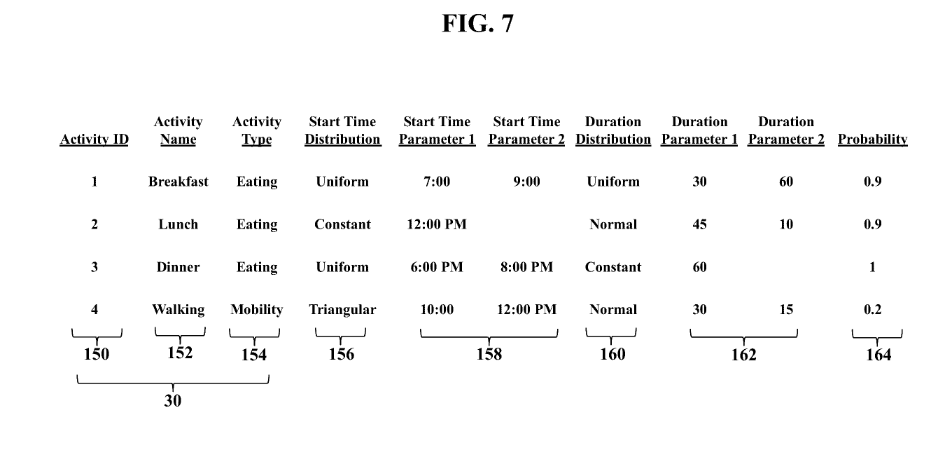

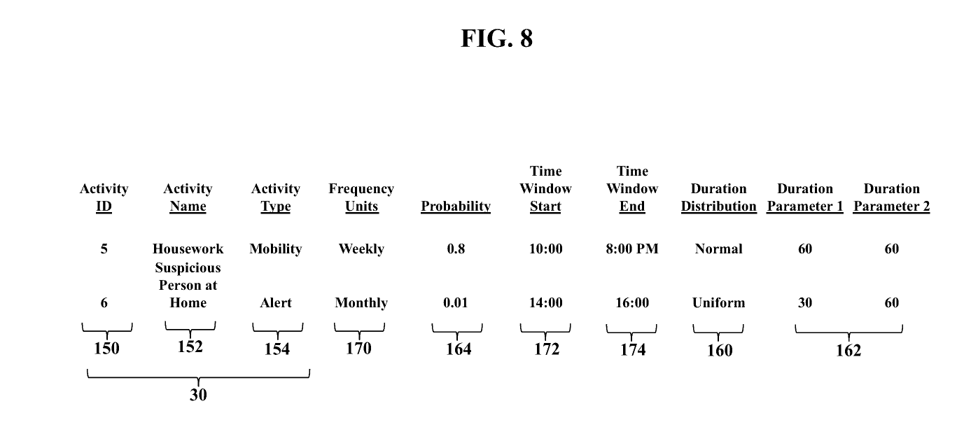

FIGS. 7-8 are schematics illustrating generation of the user's physical activities, according to exemplary embodiments. Once exemplary embodiments generate the activity profile 28, the activity profile 28 is sent via the communications network 24 to a network address associated with the server 22 (illustrated in FIG. 1). The activity profile 28 may be received as packets of data according to a packet protocol (such as any of the Internet Protocols). The packets of data contain bits or bytes of data describing the contents, or payload, of a message. A header of each packet of data may contain routing information identifying an origination address and/or a destination address. When the server receives the activity profile 28, the server-side algorithm 132 causes the server 22 to inspect the activity profile 28 for the user's physical activities 30 (as FIG. 4 illustrated).

FIG. 7 illustrates the user's daily physical activities 30. Some of the user's physical activities 30 may be performed or engaged in on a daily basis. These physical activities 30 are performed daily or nearly repeat everyday. Examples of daily physical activities 30 include eating breakfast, dressing, and toileting. Some physical activities 30 may even be performed multiple times in a single 24-hour period, in which case they will be repeated multiple times in the activity profile 28. As FIG. 7 illustrates, the user's daily physical activities 30 may be defined or specified by an activity identifier 150, a name 150, and/or an activity type 152. The activity identifier 150 may be any alphanumeric combination that uniquely identifies the physical activity 30 from all other physical activities. Each physical activity 30 may also be associated with a start time distribution 156, which may be constant, uniform, or triangular. In the case of triangular, the mode is assumed to be midway between a minimum and maximum value or parameter. Start time parameters 158 may be defined for the uniform or triangular start time distribution 156. Each physical activity 30 may also be associated with a duration distribution 160, which may be constant, uniform, or normal. Duration parameters 162 may be defined for a uniform or normal duration distribution 160. Each physical activity 30 may also be associated with a probability 164 of instantiating that particular physical activity 30 on a specific day. For each physical activity 30, exemplary embodiments may thus generate a random number to determine whether to instantiate that physical activity 30 for the specific day. If instantiating, exemplary embodiments may generate additional random numbers to determine activity start, duration and end times. FIG. 7 thus illustrates a log of the user's daily physical activities 30, which the server-side algorithm 132 generates using the user's activity profile 28.

FIG. 8 illustrates infrequent and/or random physical activities 30. As the reader likely understands, some physical activities may be irregularly performed and not on a daily basis. For example, shopping and laundry are examples of physical activities 30 that are frequently performed, but at infrequent and/or random days and times. Exemplary embodiments may still define or specify these infrequent and/or random physical activities 30. As FIG. 8 illustrates, the user's infrequent and/or random physical activities 30 may be defined or specified by the activity identifier 150, the name 150, and/or the activity type 152. Each infrequent and/or random physical activity 30 may also be associated with a frequency unit 170, such as a daily, weekly, or monthly recurrence. Here, though, the probability 164 defines a probability that the infrequent and/or random physical activity 30 will be actually performed. A time window start 172 defines a definite or range of start times of day, but an empty or null entry or value implies a start time at any time of the day. A time window end 174 defines an end time for a uniform occurrence between the start and end times. The duration distribution 160 may be constant, uniform, or normal, as also specified by the duration parameters 162. Again, for each infrequent and/or random physical activity 30, a random number is drawn to determine whether to instantiate the physical activity or not (based on the specified probability 164 of the infrequent activity). If the physical activity 30 is instantiated, exemplary embodiments may generate an additional random number to determine activity start, duration, and end times. FIG. 8 thus illustrates a log of the user's infrequent and/or random physical activities 30, which the server-side algorithm 132 generates again using the user's activity profile 28.

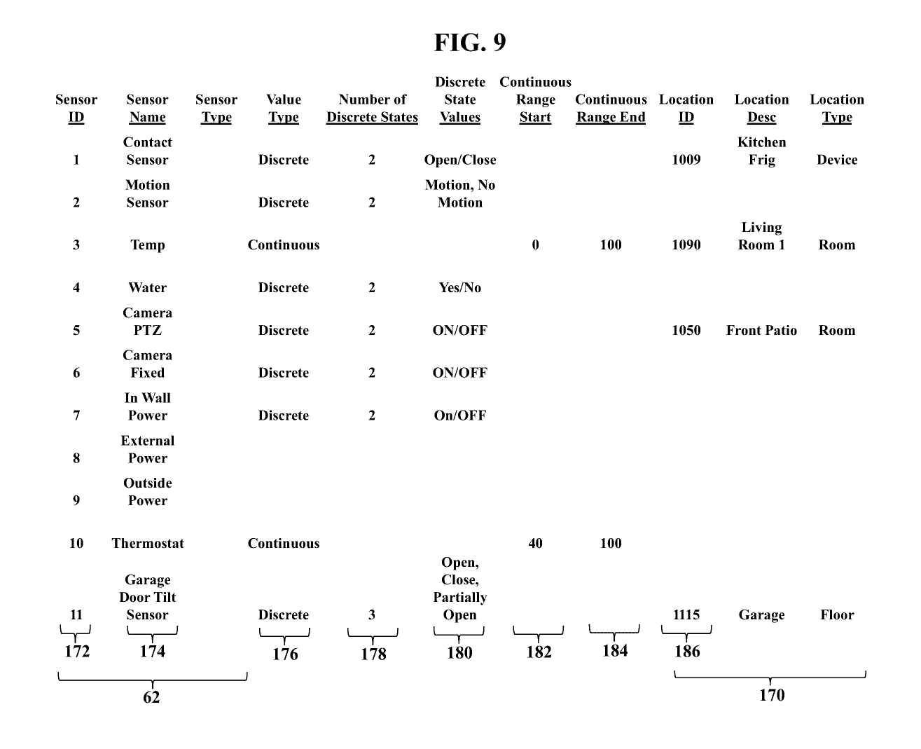

FIG. 9 is a schematic illustrating sensory definitions, according to exemplary embodiments. As this disclosure above explains, different sensors 62 may be associated with different physical locations 170. A kitchen area, for example, may have sensors for sensing motion, heat, and carbon monoxide. Other sensors may be associated with other locations 170, such as bathrooms, bedrooms, and garages. Exemplary embodiments, then, may define each different sensor 62 with various tabular or database associations describing the sensory environment. FIG. 9 thus illustrates a sensor identifier 172 and its corresponding sensor name 174 (and/or sensor type). Each sensor generates an output value type 176, such as discrete or continuous data having a range of values. Some sensors may have discrete states 178 and state values 180, such as open or close, on or off, and motion or no motion detected. If the sensor outputs continuous data, the sensor may have an associated continuous range start 182 (such as a minimum value) and a continuous range end 184 (such as a maximum value). Each sensor may have a corresponding location identifier 186 (identifying the location where the sensor is installed) and perhaps a textual description. Different sensors may thus be trained to detect different physical activities 30 in different areas.

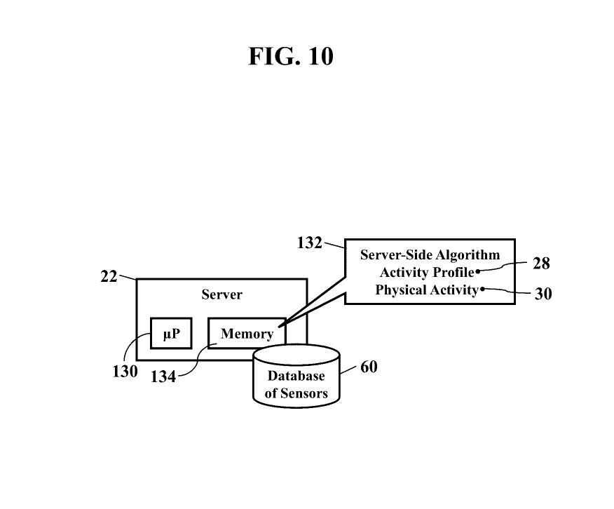

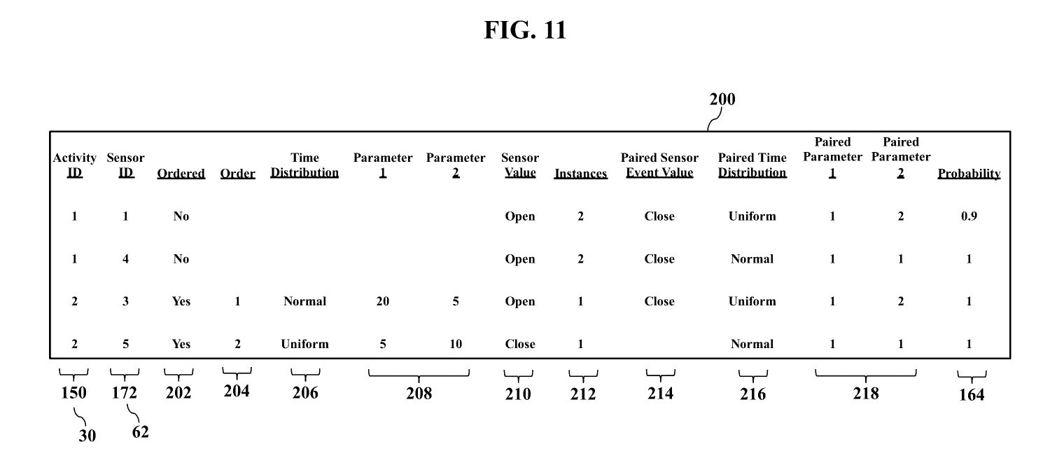

FIGS. 10-11 are schematics illustrating sensory associations, according to exemplary embodiments. FIG. 10 illustrates the server 22 receiving and locally storing the activity profile 28 in the memory 134. The activity profile 28, though, may also be remotely stored and accessed from any network location or device. Regardless, the server-side algorithm 132 causes the server 22 to inspect the activity profile 28 for the user's physical activities 30. The server-side algorithm 132 causes the server 22 to query the electronic database 60 of sensors for any physical activity 30 defined in the activity profile 28. FIG. 11 illustrates the electronic database 60 of sensors as a table 200 that electronically maps, relates, or associates different physical activities 30 to different sensor identifiers 172. For example, an entry may associate the activity identifier 150 to the corresponding sensor identifier 172. Exemplary embodiments, in simple words, define electronic database associations between a physical activity 30 (such as “breakfast”) to the sensor identifiers 172 of the sensors 62 (e.g., motion, heat, and carbon monoxide) trained to observe that physical activity 30. FIGS. 10-11 illustrate the electronic database 60 of sensors as being locally stored in the server 22, but some or all of the database entries may be remotely maintained at some other server, device, or location in the communications network (illustrated as reference numeral 24 in FIG. 1). While FIG. 11 only illustrates a few entries, in practice the database 60 of sensors may contain many entries for a large number of diverse physical activities 30 and many different sensory locations.

FIG. 11 illustrates other electronic database associations. The activity identifier 150 may be obtained from the user's daily physical activities 30 (as illustrated with reference to FIG. 7) and/or the infrequent and/or random physical activities 30 (as illustrated with reference to FIG. 8). The sensor identifier 172 may be retrieved from the sensory definitions (as illustrated with reference to FIG. 9). Each sensory event may be ordered 202 that indicates whether the sensor event occurs randomly within the physical activity (No) or is dependent on other events (Yes). If any sensory event is ordered 202, the database 60 of sensors may specify a procedure, sequence, or precedence order of the event from all the ordered events. A time distribution 206 defines a distribution (such as normal or uniform) for the time at which the sensor should be triggered, which may only be relevant when ordered 202. Parameters 208 may be defined for the time distribution 206. A sensor value 210 indicates an output value or stream of values for the sensory event. An instances 212 indicates a number of instances of sensor events to create, which may only be relevant for non-ordered events. A paired sensor event value 214 indicates dependency. Most sensor events occur in tandem, such as an opening and subsequent closing of a refrigerator door, microwave oven, and entry door. Exemplary embodiments may model these sensory events as tandem events rather than independent events, so that a dependency constraint can be easily enforced. This attribute specifies the associated paired sensor event value. A paired time distribution 216 may be uniform or normal, with associated paired event parameters 218 for paired events. The probability 164 is the probability of instating the sensory event for the corresponding physical activity 30.

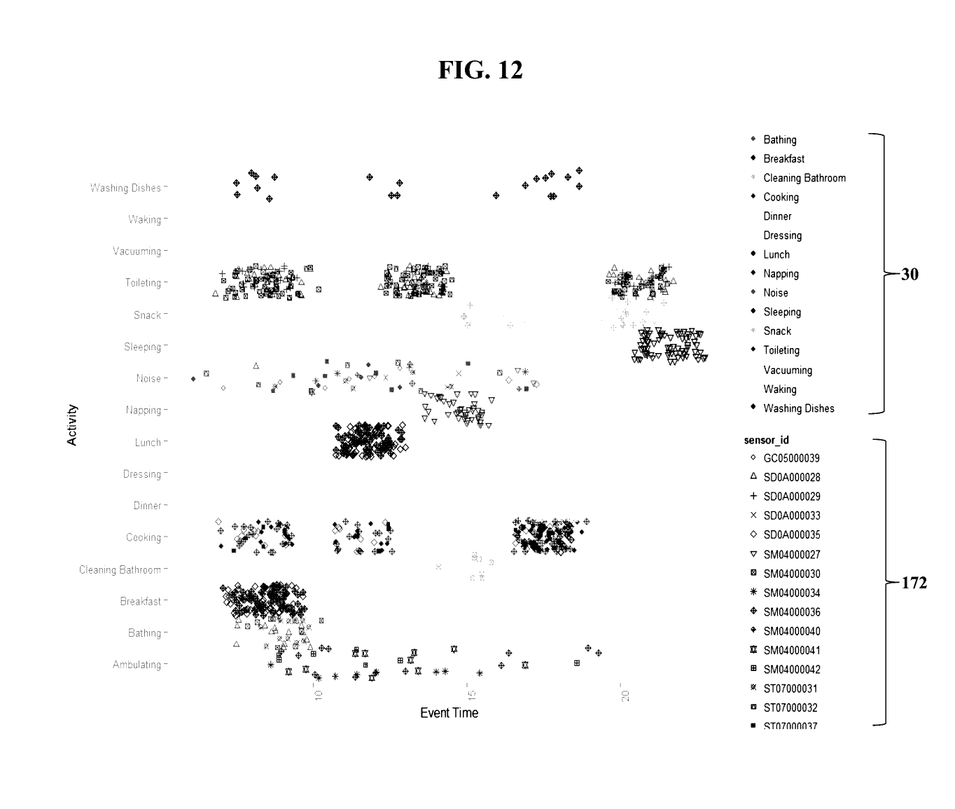

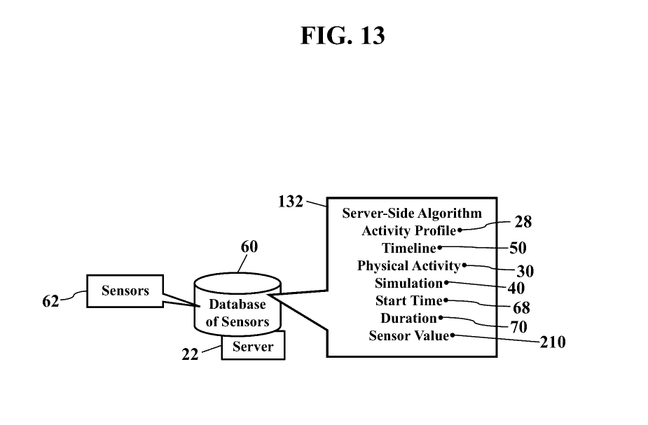

FIGS. 12-13 are schematics illustrating generation of sensory events, according to exemplary embodiments. Now that the user's physical activities 30 are known, exemplary embodiments may determine the corresponding sensors 62. FIG. 12, for example, is a graphical representation of the user's physical activities 30 and the corresponding sensor identifiers 62. As FIG. 13 illustrates, once the sensor identifiers 62 are known, exemplary embodiments may thus generate the sensory events 72 that simulate the user's timeline 50 of her physical activities 30. The server-side algorithm 132 replays or recreates the timeline 50 using the fabricated sensory data 66 that corresponds to each sensor identifier 172. The server 22 generates the simulation 40 of the sensory events 72 using the fabricated electronic data 66 based on historically observed sensory outputs and/or a statistical distribution of sensor outputs. Regardless, the server-side algorithm 132 simulates the sensory outputs that would be generated while monitoring the user's physical activities 30, according to sensor instantiations as defined by the user's activity profile 28.

Exemplary embodiments thus simulate sensory outputs generated by the user's daily, infrequent, and/or random physical activities 30. As the server-side algorithm 132 recreates the user's timeline 50 of physical activities 30, the server-side algorithm 132 calls or invokes the corresponding sensory outputs. Whenever a physical activity 30 is instantiated, the server-side algorithm 132 may check all the unordered sensor events that need to be instantiated (based on the corresponding probability 164). The sensory event may be uniformly instantiated across the duration 70 of the physical activity 30. If multiple instances are specified for an unordered sensory event (with reference to FIG. 11), the server-side algorithm 132 may instantiate the specified number of events uniformly during the duration 70. The server-side algorithm 132 may set the corresponding sensor value 210 to the specified value at these events. If the sensor output is continuous (as explained with reference to FIG. 8), the server-side algorithm 132 may select a value uniformly between the (Min, Max) specified in the sensor definition. The server-side algorithm 132 may select the ordered sensor event with an order of one (1) and instantiate based on the time distribution 206 and the parameters 208 (illustrated with reference to FIG. 11). These values are relative to a start of the corresponding physical activity 30. The server-side algorithm 132 may select the ordered sensor event with an order of two (2) and instantiate based on the time distribution 206 and the parameters 208. These values are relative to the order of one (1) sensor event. The server-side algorithm 132 may similarly process all ordered sensor events. For each of the processed events, the server-side algorithm 132 may check if there is paired sensor event defined and, if so, instantiate the paired event at the specified time (based on the paired time distribution 216 and the paired event parameters 218 also illustrated with reference to FIG. 11).

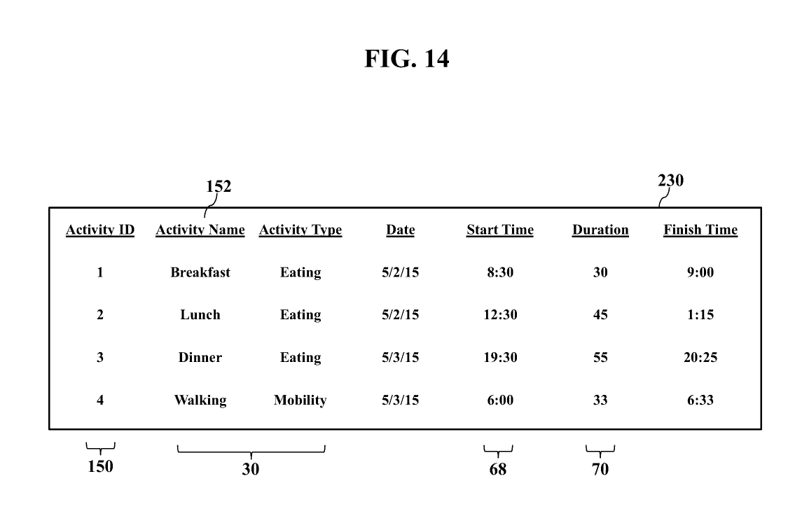

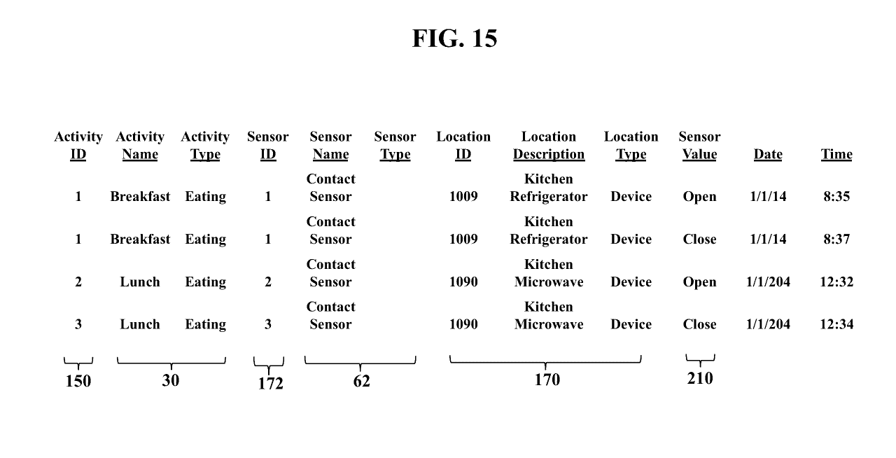

FIGS. 14-16 are more detailed schematics illustrating output generation, according to exemplary embodiments. FIG. 14 illustrates an electronic log 230 of the different physical activities 30, as replayed or recreated according to the user's activity profile (illustrated as reference numeral 28 in FIG. 13). As the server-side algorithm 132 activates each physical activity 30, the server-side algorithm 132 may generate the electronic log 230 of the different physical activities during the modeling simulation 40. As FIG. 15 illustrates, as each physical activity 30 (as identified by the activity identifier 150 and activity name 152) and associated sensor event (as identified by the sensor identifier 172 and other sensory information) is activated, exemplary embodiments may generate detailed information describing simulated instantiation of the sensory output value 210, the date, and the time.

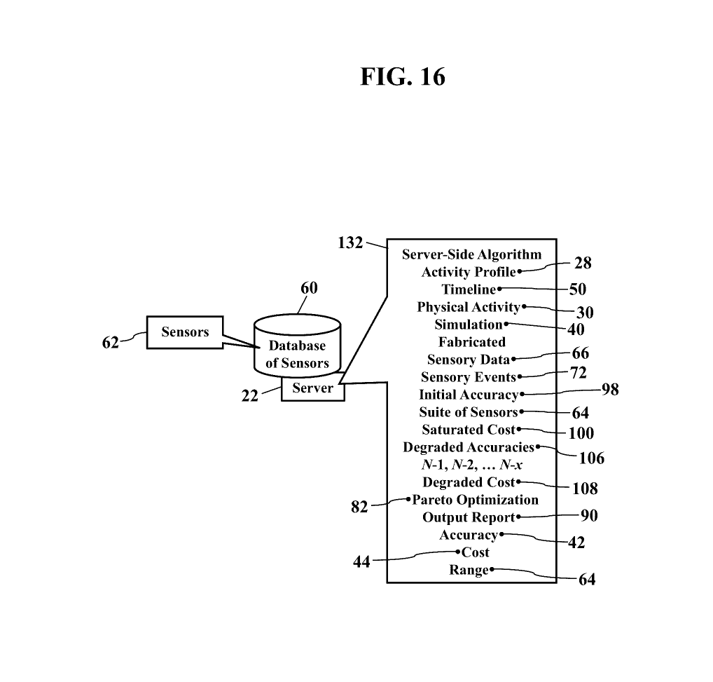

FIG. 16 further illustrates the output report 90. Once the server-side algorithm 132 generates the initial baseline analysis, the server-side algorithm 132 generates the initial accuracy 80. As the above paragraphs explained, the initial accuracy 98 is determined using all the sensors 62 specified for each physical activity 30 in the user's activity profile 28. The server-side algorithm 132 may thus ingest all the fabricated sensory data 66 for all the sensors 62 to determine the initial accuracy 98 in predicting the user's physical activities 30. The initial accuracy 98 thus utilizes the dense and diverse suite 64 of sensors defined for all the user's physical activities 30. The server-side algorithm 132 may also generate the saturated cost 100 that accounts for the dense and diverse suite 64 of sensors.

Exemplary embodiments may then generate the one or more degraded accuracies 106. As the dense and diverse suite 64 of sensors may be unsuited to many customers, some users may prefer a reduced combination of sensors in exchange for a lower cost and/or an easier installation. The server-side algorithm 132 may then sequentially or successively reduce the number N of the sensors and re-simulate the sensory events 72 associated with each physical activity 30 in the user's activity profile 28. FIG. 16 thus illustrates several subsequent degraded accuracies 106 for (N−1), (N−2), . . . , (N−x) sensors 62 and each corresponding degraded cost 108.

The Pareto optimization 82 simplifies the output. As exemplary embodiments successively generate the simulation using a lesser number of the sensors 62, the server-side algorithm 132 tests the resulting degradation in activity recognition and assigns the corresponding degraded accuracy 106 and the corresponding degraded cost 108. The Pareto optimization 82 quantifies the tradeoff between the different accuracies 42 and the different costs 44. The server-side algorithm 132 may implement the Pareto optimization 82 as a Pareto curve in two dimensions to generate an optimal set of sensors for any given desired accuracy. The output report 90 may summarize each iteration with the corresponding accuracy 42 and cost 44, thus presenting the range 46 of sensory alternatives for different sensory scenarios.

Exemplary embodiments thus balance accuracy and affordability. As each iteration removes another one of the sensors 62, exemplary embodiments test the resulting degradation in activity recognition. The output report 90 thus graphically presents different balance point(s) between activity recognition accuracy and sensor affordability. A very high value or level of the accuracy 42 may require many sensors 62, which may be too costly for some users. However, at some point the number of the sensors 62 may be too low, producing a low accuracy 42 that is unacceptable to the user. The range 46 of sensory alternatives may thus visually present acceptable compromises between the accuracy 42 and the cost 44. Again, then, the user may thus choose a sensory installation package that best suits her needs and her budget.

Exemplary embodiments may determine the accuracies 42 using any scheme. The initial accuracy 80 and the one or more degraded accuracies 42 may be calculated using the same or different algorithm or formula. Any measure or value of accuracy may be according to an objective determination, such as a comparison to actual real world sensory data, condition, experiment, or prediction. However, accuracy may also be subjective according to experience, emotion (e.g., fear of falling or being out-of-detection area), and installation preference and aesthetic.

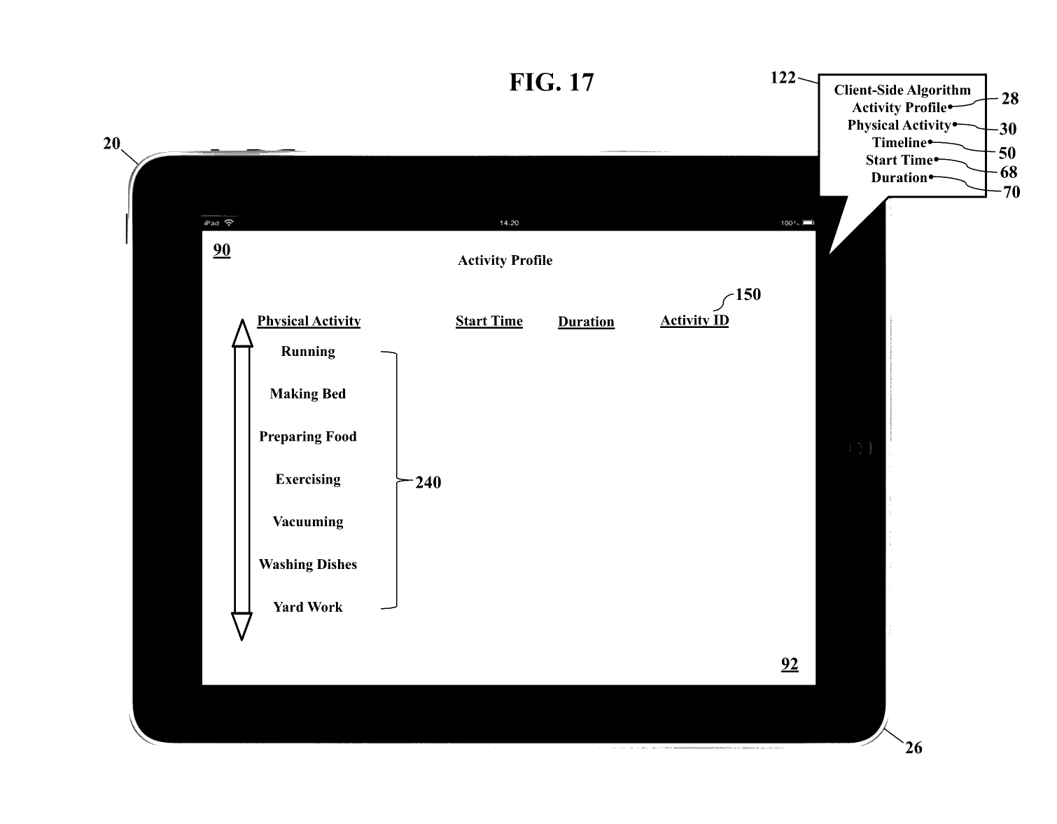

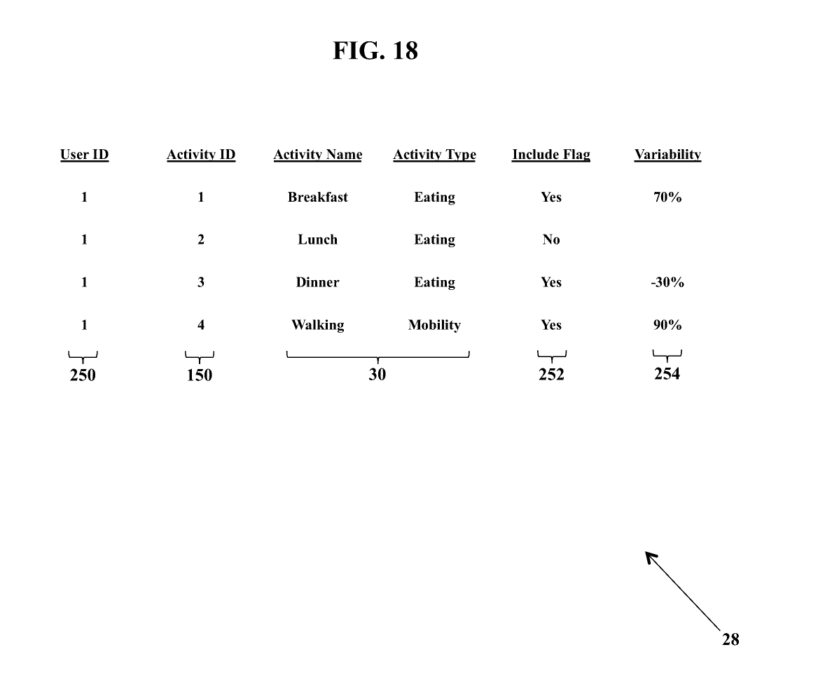

FIGS. 17-18 are more detailed schematics illustrating the activity profile 28, according to exemplary embodiments. This disclosure explains that the activity profile 28 may be personalized to suit the user's physical abilities and interests. Some physical activities 30 will be common and even popular across a population of users. Other physical activities 30 may be less popular, uncommon, unusual, and/or even unique. FIG. 17 thus illustrates a menu 240 of physical activities 30. As the mobile tablet computer 26 executes the client-side algorithm 122, the client-side algorithm 122 causes the mobile tablet computer 26 to generate the menu 240 of physical activities 30 for display in the graphical user interface 90. The user may thus scroll or navigate and select her desired physical activity 30, enter its corresponding start time 68, and enter its corresponding duration 70. The menu 240 of physical activities 30 may thus be pre-populated with physical activities 30 that are common to many users. The menu 240 of physical activities 30 may also include blank fields or other features permitting manual entry of less common physical activities. Regardless, the client-side algorithm 122 may generate a simple user interface that assists the user in specifying her activity profile 28.

FIG. 17 further illustrates the activity profile 28. As there may be many different physical activities 30, exemplary embodiments may assign the unique physical activity identifier 150. The physical activity identifier 150 may be any alphanumeric combination that is uniquely associated with the corresponding physical activity 30. As the user selects or enters her desired physical activity 30 using the menu 240, the client-side algorithm 122 may retrieve and/or add the corresponding physical activity identifier 150. Alternatively, the server-side algorithm 132 may query the database 60 of sensors for the physical activity 30 and retrieve the corresponding physical activity identifier 150 (as illustrated with reference to FIG. 16). The database 60 of sensors may thus store electronic database associations between different physical activities 30, different physical activity identifiers 150, the different sensors 62, and the different sensor identifiers 172.

FIG. 18 further illustrates the activity profile 28. The activity profile 28 thus describes the user's physical activities 30. As there may be many activity profiles 28 for many different users, each activity profile 28 may be associated with a unique user identifier 250 assigned to the user. A logical flag 252 may also be associated with the physical activity 30. The flag 252 indicates whether or not the user performs the corresponding physical activity 30. If the flag 252 is null, empty, or set to “No,” the corresponding physical activity 30 is not instantiated for that user.

A variability 254 may also be defined or indicated for the corresponding physical activity 30. The variability 254 may be a parameter or value that measures or indicates how much the user differs from any normal pattern or population. For example, the variability 254 may be a percentage of daily participation of that physical activity 30, which may be defined or calculated in relation to the duration (illustrated, for example, as reference numeral 70 in FIGS. 6-8 and 13-15) of the corresponding physical activity 30. The duration 70 may be multiplied by (1—variability). If the variability 254 is ten percent (10%), the duration 70 is changed to 90% of its original value. If the variability 254 is negative thirty percent (−30%), the duration 70 is 130% of its original value. If the variability 254 is 100%, the physical activity 30 may not instantiated for that user.

The sensor events 72 may thus be configured. Once the activity profile 28 is configured, exemplary embodiments may configure the contents of the physical activity 30 in terms of the sensor events 72. Recall that the database 60 of sensors includes or defines electronic database associations between different physical activities 30, different sensors 62, and different sensory events 72. Based on the variability 254, a random number is used to determine if an unordered sensor event is to be included for that user or not. Consider the case where the user's content variability is 70%. That means, only 30% (100−70) of the unordered sensor events will be instantiated for that user in that physical activity 30. If the variability 254 is negative (such as −30%), one sensor event of that type is included in every physical activity 30 of that user (accounting for 100%) and a random number are used to instantiate additional 30% of sensor events for that physical activity 30.

Exemplary embodiments may configure once per simulation. Assume, for example, that physical activity A1 has sensor events S1, S2, and S3. If the user deviates from this physical activity by 70%, she will have only 30% of the sensor events instantiated. If a random number selection picks S2 and eliminates S1 and S3, this selection may be held constant from the entire simulation. This user will have S2 in physical activity A1 for the entire simulation. Exemplary embodiments may not want random numbers to pick S1 of day 1, S3 of day 2, etc. Instead, exemplary embodiments may prefer to utilize a similar configuration throughout the simulation.

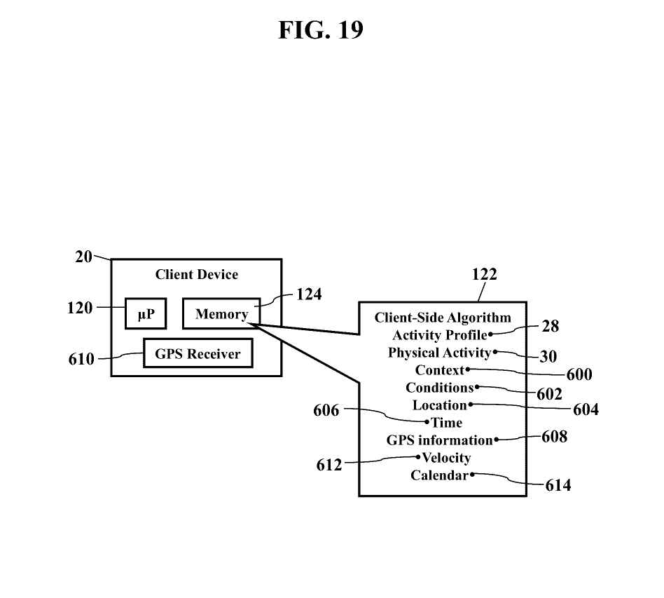

FIG. 19 is a schematic activity inferences, according to exemplary embodiments. As the user carries her client device 20 (such as the mobile tablet computer 26 illustrated in FIGS. 1-2), exemplary embodiments may infer the user's physical activities 30. For example, the physical activity 30 may be inferred based on context 600. As the reader may understand, as the client device 20 is carried and used throughout the day, various conditions 602 change. The conditions 602 may determine the current situational context 600. The conditions 602, for example, may include a geographic location 604 and a time 606 that the client device 20 is currently being used. As the client device 20 moves, exemplary embodiments may acquire global positioning system (“GPS”) information 608 using a GPS receiver 610. Changes in the geographic location 604 and the time 606, as determined by changes in the GPS information 608, may be used to determine a speed or velocity 612 of movement. Exemplary embodiments may thus use the geographic location 604, the time 606, and/or the velocity 612 to infer the user's physical activity 30, especially if habitually observed. For example, repeated observances of activity in the kitchen may be used to infer preparation of breakfast during morning hours. Similarly, movement in a laundry room may indicate laundry activities, while the geographic location 604 in the bathroom may indicate toileting activities.

Inferences may also be based on the user's calendar. As the reader also understands, the client device 20 may store and maintain the user's electronic calendar 614 using an electronic calendar application. Exemplary embodiments may thus use entries in the electronic calendar 614 to infer the user's physical activity 30.

Inferences may also acquire output from other mobile sensors. The client device 20, for example, may have an accelerometer and a temperature sensor. Output values from the accelerometer may be used to help determine the physical activity 30, such as distinguishing walking from running Output values from the accelerometer may also determine stationary physical activities 30, such as sit-ups or treadmill. Output values from the temperature sensor may distinguish between indoor and outdoor activities.

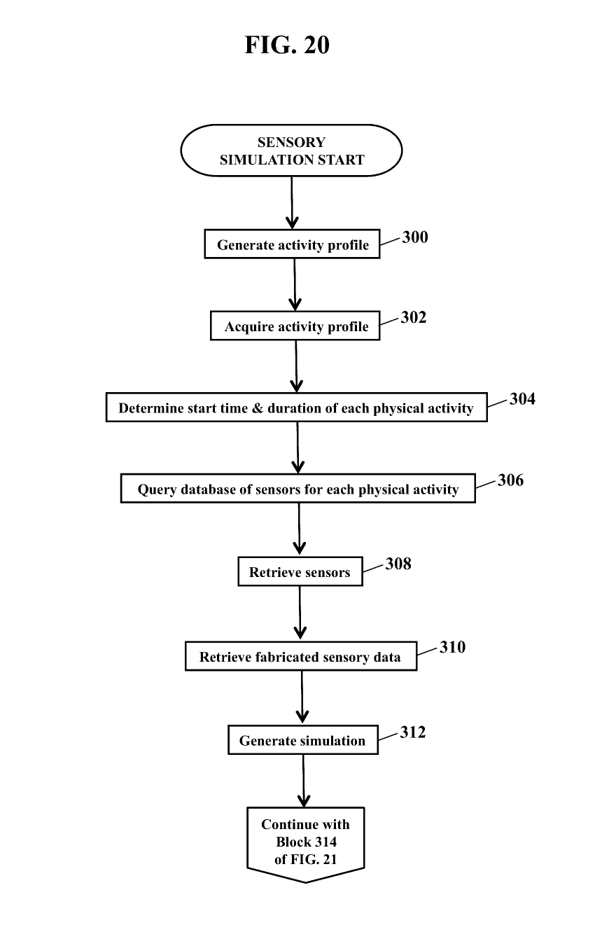

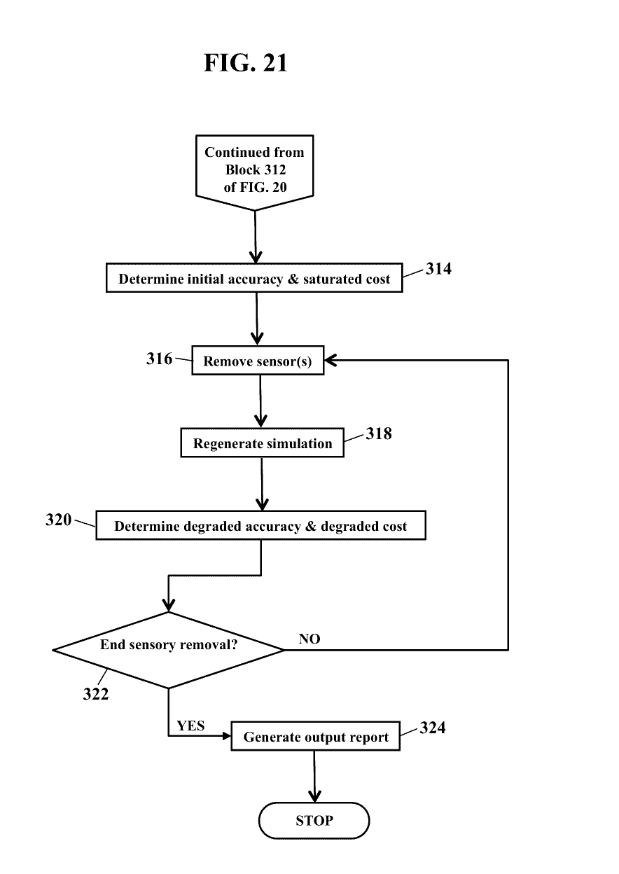

FIGS. 20-21 are flowcharts illustrating a method or algorithm for sensory simulations, according to exemplary embodiments. The user's activity profile 28 is generated (Block 300) and acquired by the server (Block 302). The start time 68 and the duration 70 of each physical activity 30 are determined (Block 304). The database 60 of sensors is queried for each physical activity 30 (Block 306) and the corresponding sensors 62 and/or sensor identifiers 172 are retrieved (Block 308). The fabricated sensory data 66 is retrieved (Block 310) and the simulation 40 is generated (Block 312).

The flowchart continues with FIG. 21. Once the simulation 40 is generated, the initial accuracy 98 and the saturated cost 100 are determined (Block 314). One or more sensors 30 may be removed (Block 316) and the simulation 40 is regenerated (Block 318). The degraded accuracy 106 and the degraded cost 108 are determined (Block 320). When sensory removal ends (Block 322), the output report 90 is generated (Block 324).

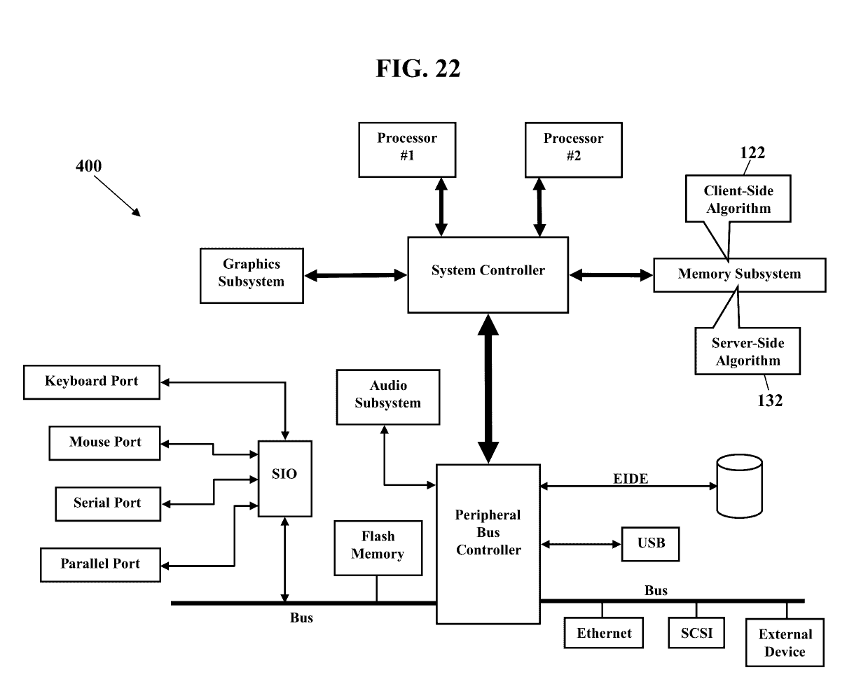

FIG. 22 is a schematic illustrating still more exemplary embodiments. FIG. 22 is a more detailed diagram illustrating a processor-controlled device 400. As earlier paragraphs explained, the client-side algorithm 122 and/or the server-side algorithm 132 may partially or entirely operate in any mobile or stationary processor-controlled device. FIG. 22, then, illustrates the client-side algorithm 122 and/or the server-side algorithm 132 stored in a memory subsystem of the processor-controlled device 400. One or more processors communicate with the memory subsystem and execute either, some, or all applications. Because the processor-controlled device 400 is well known to those of ordinary skill in the art, no further explanation is needed.

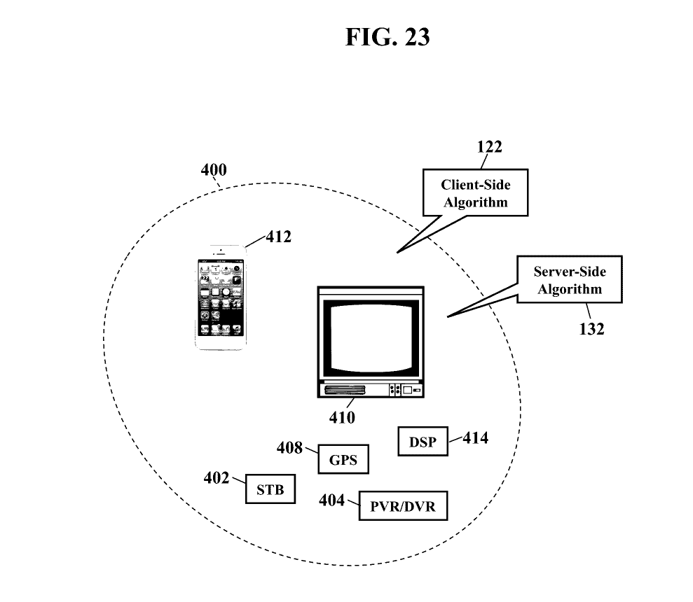

FIG. 23 depicts other possible operating environments for additional aspects of the exemplary embodiments. FIG. 23 illustrates the client-side algorithm 122 and/or the server-side algorithm 132 operating within various other processor-controlled devices 400. FIG. 23, for example, illustrates that the client-side algorithm 122 and/or the server-side algorithm 132 may entirely or partially operate within a set-top box (“STB”) (402), a personal/digital video recorder (PVR/DVR) 404, a Global Positioning System (GPS) device 408, an interactive television 410, a smartphone 412, or any computer system, communications device, or processor-controlled device utilizing any of the processors above described and/or a digital signal processor (DP/DSP) 414. Moreover, the processor-controlled device 400 may also include wearable devices (such as watches), radios, vehicle electronics, clocks, printers, gateways, mobile/implantable medical devices, and other apparatuses and systems. Because the architecture and operating principles of the various devices 400 are well known, the hardware and software componentry of the various devices 400 are not further shown and described.

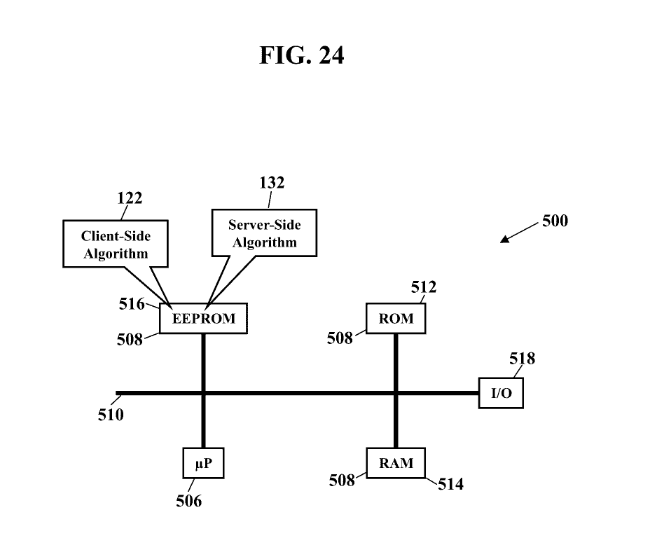

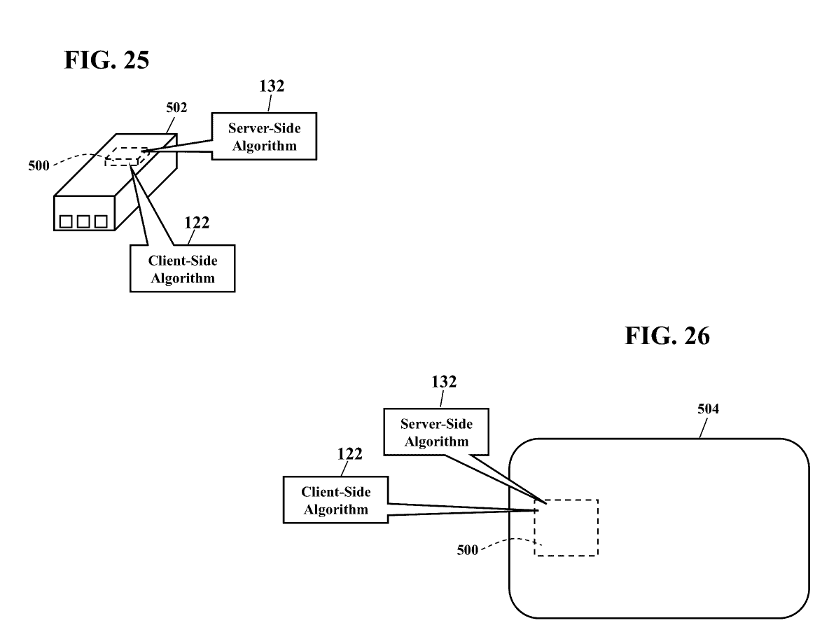

FIGS. 24-27 are schematics further illustrating operating environments for additional aspects of the exemplary embodiments. FIG. 24 is a block diagram of a Subscriber Identity Module 500, while FIGS. 25 and 26 illustrate, respectively, the Subscriber Identity Module 500 embodied in a plug 502 and in a card 504. As those of ordinary skill in the art recognize, the Subscriber Identity Module 500 may be used in conjunction with many communications devices (such as the mobile tablet computer 26 and the smartphone 412). The Subscriber Identity Module 500 stores user information (such as the user's International Mobile Subscriber Identity, the user's Kᵢ number, and other user information) and any portion of the client-side algorithm 122 and/or the server-side algorithm 132. As those of ordinary skill in the art also recognize, the plug 502 and the card 504 each may physically or wirelessly interface with the mobile tablet computer 26 and the smartphone 412.

FIG. 24 is a block diagram of the Subscriber Identity Module 500, whether embodied as the plug 502 of FIG. 25 or as the card 504 of FIG. 26. Here the Subscriber Identity Module 500 comprises a microprocessor 506 (μP) communicating with memory modules 508 via a data bus 510. The memory modules 508 may include Read Only Memory (ROM) 512, Random Access Memory (RAM) and or flash memory 514, and Electrically Erasable-Programmable Read Only Memory (EEPROM) 516. The Subscriber Identity Module 500 stores some or all of the client-side algorithm 122 and/or the server-side algorithm 132in one or more of the memory modules 508. FIG. 24 shows the client-side algorithm 122 and/or the server-side algorithm 132 residing in the Erasable-Programmable Read Only Memory 516, yet either module may alternatively or additionally reside in the Read Only Memory 512 and/or the Random Access/Flash Memory 514. An Input/Output module 518 handles communication between the Subscriber Identity Module 500 and the communications device. Because Subscriber Identity Modules are well known in the art, this patent will not further discuss the operation and the physical/memory structure of the Subscriber Identity Module 500.

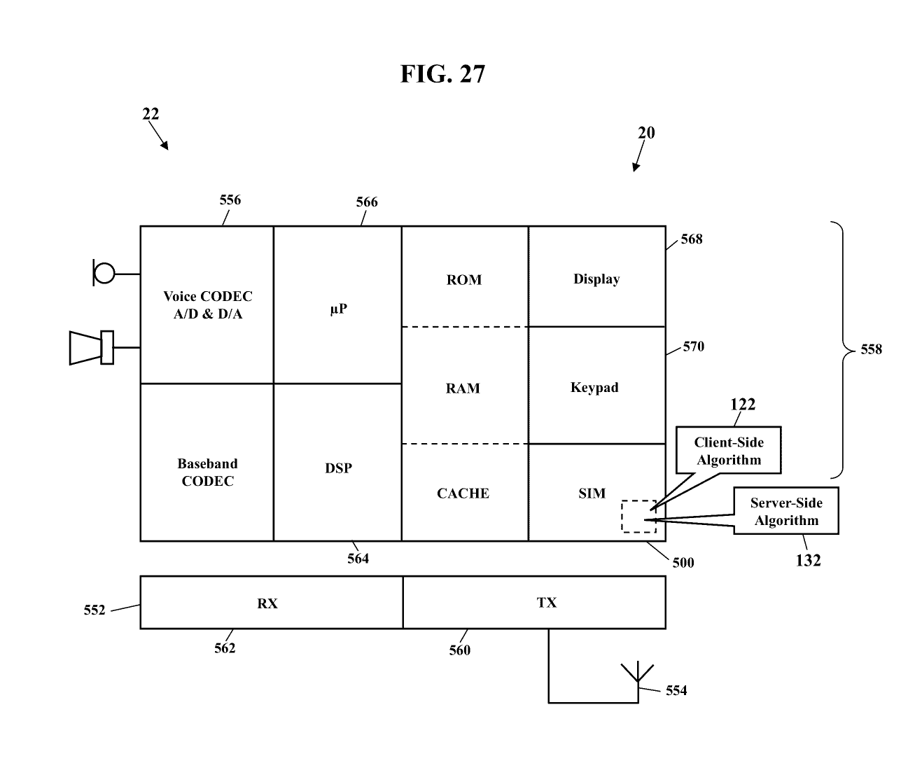

FIG. 27 is a schematic further illustrating the operating environment, according to exemplary embodiments. FIG. 27 is a block diagram illustrating some componentry of the client device 20 and/or the server 22. The componentry may include one or more radio transceiver units 552, an antenna 554, a digital baseband chipset 556, and a man/machine interface (MMI) 558. The transceiver unit 552 includes transmitter circuitry 560 and receiver circuitry 562 for receiving and transmitting radio-frequency (RF) signals. The transceiver unit 552 couples to the antenna 554 for converting electrical current to and from electromagnetic waves. The digital baseband chipset 556 contains a digital signal processor (DSP) 564 and performs signal processing functions for audio (voice) signals and RF signals. As FIG. 27 shows, the digital baseband chipset 556 may also include an on-board microprocessor 566 that interacts with the man/machine interface (MMI) 558. The man/machine interface (MMI) 558 may comprise a display device 568, a keypad 570, and the Subscriber Identity Module 500. The on-board microprocessor 566 may also interface with the Subscriber Identity Module 500 and with the client-side algorithm 122 and/or the server-side algorithm 132.

Exemplary embodiments may be applied to any signaling standard. As those of ordinary skill in the art recognize, FIGS. 24-27 may illustrate a Global System for Mobile (GSM) communications device. That is, the client device 20 and/or the server 22 may utilize the Global System for Mobile (GSM) communications signaling standard. Those of ordinary skill in the art, however, also recognize that exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH®, and any other.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for sensory simulations, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A system, comprising:
a processor; and
a memory storing instructions that when executed cause the processor to perform operations, the operations comprising:
receiving an electronic activity profile describing a timeline of physical activities associated with a user;
querying an electronic database for the physical activities described in the electronic activity profile, the electronic database having electronic database associations between different sensors and different physical activities including the physical activities described in the electronic activity profile;
retrieving sensory identifiers of sensors from the electronic database having the electronic database associations with the physical activities described in the electronic activity profile;
retrieving fabricated sensory data that corresponds to the sensory identifiers of the sensors having the electronic database associations with the physical activities described in the electronic activity profile; and
generating an electronic simulation of the sensors detecting the physical activities using the fabricated sensory data according to the timeline.

2. The system of claim 1, wherein the operations further comprise determining an accuracy associated with the electronic simulation.

3. The system of claim 2, wherein the operations further comprise removing at least one of the sensors and regenerating the electronic simulation using a reduced number of the sensors.

4. The system of claim 3, wherein the operations further comprise determining a degraded accuracy associated with the electronic simulation regenerated using the reduced number of the sensors.

5. The system of claim 1, wherein the operations further comprise simulating a start time of a physical activity described in the electronic activity profile.

6. The system of claim 1, wherein the operations further comprise simulating a duration of a physical activity described in the electronic activity profile.

7. The system of claim 1, wherein the operations further comprise determining a numerical count of the sensors having the electronic database associations with the physical activities described in the electronic activity profile.

8. The system of claim 7, wherein the operations further comprise determining a reduced count of the sensors.

9. The system of claim 8, wherein the operations further comprise regenerating the electronic simulation using the reduced count of the sensors.

10. A method, comprising:
receiving, by a server, an electronic activity profile describing a timeline of physical activities associated with a user;
querying, by the server, an electronic database for the physical activities described in the electronic activity profile, the electronic database having electronic database associations between different sensors and different physical activities including the physical activities described in the electronic activity profile;
retrieving, by the server, sensory identifiers of sensors from the electronic database having the electronic database associations with the physical activities described in the electronic activity profile;
retrieving, by the server, fabricated sensory data that corresponds to the sensory identifiers of the sensors having the electronic database associations with the physical activities described in the electronic activity profile; and
generating, by the server, an electronic simulation of the sensors detecting the physical activities using the fabricated sensory data according to the timeline.

11. The method of claim 10, further comprising determining an accuracy associated with the electronic simulation.

12. The method of claim 11, further comprising removing at least one of the sensors and regenerating the electronic simulation using a reduced number of the sensors.

13. The method of claim 12, further comprising determining a degraded accuracy associated with the electronic simulation regenerated using the reduced number of the sensors.

14. The method of claim 10, further comprising simulating a start time of a physical activity described in the electronic activity profile.

15. The method of claim 10, further comprising simulating a duration of a physical activity described in the electronic activity profile.

16. A memory device storing instructions that when executed cause a processor to perform operations, the operations comprising:
receiving an electronic activity profile describing a timeline of physical activities associated with a user;
querying an electronic database for the physical activities described in the electronic activity profile, the electronic database having electronic database associations between different sensors and different physical activities including the physical activities described in the electronic activity profile;
retrieving sensory identifiers of sensors from the electronic database having the electronic database associations with the physical activities described in the electronic activity profile;
retrieving fabricated sensory data that corresponds to the sensory identifiers of the sensors having the electronic database associations with the physical activities described in the electronic activity profile; and
generating an electronic simulation of the sensors detecting the physical activities using the fabricated sensory data according to the timeline.

17. The memory device of claim 16, wherein the operations further comprise determining an accuracy associated with the electronic simulation.

18. The memory device of claim 17, wherein the operations further comprise removing at least one of the sensors and regenerating the electronic simulation using a reduced number of the sensors.

19. The memory device of claim 18, wherein the operations further comprise determining a degraded accuracy associated with the electronic simulation regenerated using the reduced number of the sensors.

20. The memory device of claim 16, wherein the operations further comprise simulating a start time of a physical activity described in the electronic activity profile.
